(19) United States
(12) Patent Application Publication
(10) Pub. No.: US 2021/0279375 A1
(43) Pub. Date: Sep. 9, 2021

(54) INFORMATION PROCESSING DEVICE, THREE-DIMENSIONAL SHAPE DATA GENERATION DEVICE, THREE-DIMENSIONAL SHAPING DEVICE, AND NON-TRANSITORY COMPUTER READABLE MEDIUM

(71) Applicant: FUJIFILM BUSINESS INNOVATION CORP., Tokyo (JP)

(72) Inventors: Shigeyuki SAKAKI, Kanagawa (JP); Satoshi HASEBE, Kanagawa (JP)

(73) Assignee: FUJIFILM BUSINESS INNOVATION CORP., Tokyo (JP)

(21) Appl. No.: 16/930,709

(22) Filed: Jul. 16, 2020

(30) Foreign Application Priority Data
Mar. 6, 2020 (JP) 2020-039319

(51) Int. Cl. G06F 30/10

(52) U.S. Cl. CPC G06F 30/10; G06F 2111/04

(57) ABSTRACT

An information processing device includes a processor configured to: when designing a three-dimensional shape made of an anisotropic material that is a material having physical property values in different directions, acquire (i) the physical property values of the anisotropic material in respective directions and (ii) performance information that is information regarding (a) a required performance that the three-dimensional shape is required to have and (b) a required direction in which the three-dimensional shape is required to exhibit the required performance, derive information for arranging the anisotropic material such that the required direction corresponds to a direction of the anisotropic material satisfying the required performance, and output the information for arranging the anisotropic material.

### CROSS-REFERENCE TO RELATED APPLICATIONS

This application is based on and claims priority under 35 USC 119 from Japanese Patent Application No. 2020-039319 filed Mar. 6, 2020.

### BACKGROUND

### 1. Technical Field

The present disclosure relates to an information processing device, a three-dimensional shape data generation device, a three-dimensional shaping device, and a non-transitory computer readable medium.

### 2. Related Art

JP-A-2012-74072 discloses a method of three-dimensionally controlling and manufacturing an object having a potential [x] generated corresponding to a field [f] applied to the object. By separating external shape data of the object into plural finite elements, a computer-processable mathematical model of the object is generated, and the symmetry of a physical property value of each finite element is specified. Each numerical value of a field [f] and a potential [x] related to each finite element is specified, an unknown physical property matrix [k] of a material of the object is calculated based on the relational expression [f]=[k][x] and the symmetry, and the coefficient of the physical property value of the material for each finite element within the computer-processable mathematical model of the object is extracted from the calculated physical property matrix [k]. In order to match the coefficient of the physical property value of the extracted material with the coefficient of the physical property value of a known material, the coefficient of the physical property value of the extracted material is compared with the coefficient of the physical property value of the known material. Each manufacturing parameter for controlling a manufacturing apparatus for each finite element of the object is determined based on each coefficient of the physical property value of the matched material, and a machine control instruction for controlling manufacturing equipment according to each manufacturing parameter is generated.

### SUMMARY

Metallic materials and fiber-reinforced plastics in which carbon fibers are bundled have a directional dependency on physical property values such as material strength and electrical conductivity. Materials such as metallic materials and fiber-reinforced plastics whose physical property values have the directional dependency are called anisotropic materials.

For example, it is assumed that in designing a three-dimensional shape made of an anisotropic material, a direction in which a load is applied to the three-dimensional shape corresponds to a direction in which the strength of the anisotropic material is weak. When the three-dimensional shape is shaped in this case, the three-dimensional shape may not have a required strength and thus may be broken.

That is, in designing the three-dimensional shape made of the anisotropic material, a required performance may not be obtained in a required direction.

Aspects of non-limiting embodiments of the present disclosure relate to an information processing device, a three-dimensional shape data generation device, a three-dimensional shaping device, and a non-transitory computer readable medium that are capable of obtaining a required performance in a required direction in designing a three-dimensional shape made of an anisotropic material.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, an information processing device including a processor configured to: when designing a three-dimensional shape made of an anisotropic material that is a material having physical property values in different directions, acquire (i) the physical property values of the anisotropic material in respective directions and (ii) performance information that is information regarding (a) a required performance that the three-dimensional shape is required to have and (b) a required direction in which the three-dimensional shape is required to exhibit the required performance, derive information for arranging the anisotropic material such that the required direction corresponds to a direction of the anisotropic material satisfying the required performance, and output the information for arranging the anisotropic material.

### BRIEF DESCRIPTION OF THE DRAWINGS

Exemplary embodiment(s) of the present disclosure will be described in detail based on the following figures, wherein:

FIG. 1 is a configuration diagram illustrating an example of a three-dimensional shaping system according to each exemplary embodiment;

FIG. 2 is a configuration diagram illustrating an example of an information processing device according to each exemplary embodiment;

FIG. 3 is a block diagram illustrating an example of a functional configuration of the information processing device according to each exemplary embodiment;

FIGS. 4A and 4B are schematic diagrams illustrating an example of a three-dimensional shape, which is used to explain the principal stress according to each exemplary embodiment;

FIGS. 5A and 5B are schematic diagrams illustrating an example of a crystal structure of an anisotropic material, which is used to explain the strength of a crystal according to each exemplary embodiment;

FIG. 6 is a schematic diagram illustrating an example of a three-dimensional shape according to each exemplary embodiment;

FIG. 7 is a configuration diagram illustrating an example of a three-dimensional shaping device according to each exemplary embodiment;

FIG. 8 is a schematic diagram illustrating an example of a three-dimensional shape, which is used to explain the principal stress applied to a portion of a three-dimensional shape according to each exemplary embodiment;

FIG. 9 is a schematic diagram illustrating an example of an anisotropic material, which is used to explain the arrangement of the anisotropic material according to each exemplary embodiment;

FIG. 10 is a flowchart illustrating an example of information processing according to a first exemplary embodiment;

FIG. 11 is a view illustrating an example of a central axis, a strong axis, a maximum principal stress, and an intermediate principal stress, which are used to explain the direction alignment according to a second exemplary embodiment; and

FIG. 12 is a flowchart illustrating an example of information processing according to the second exemplary embodiment.

### DETAILED DESCRIPTION

### [First Exemplary Embodiment]

Hereinafter, exemplary embodiments of the present disclosure will be described in detail with reference to the drawings.

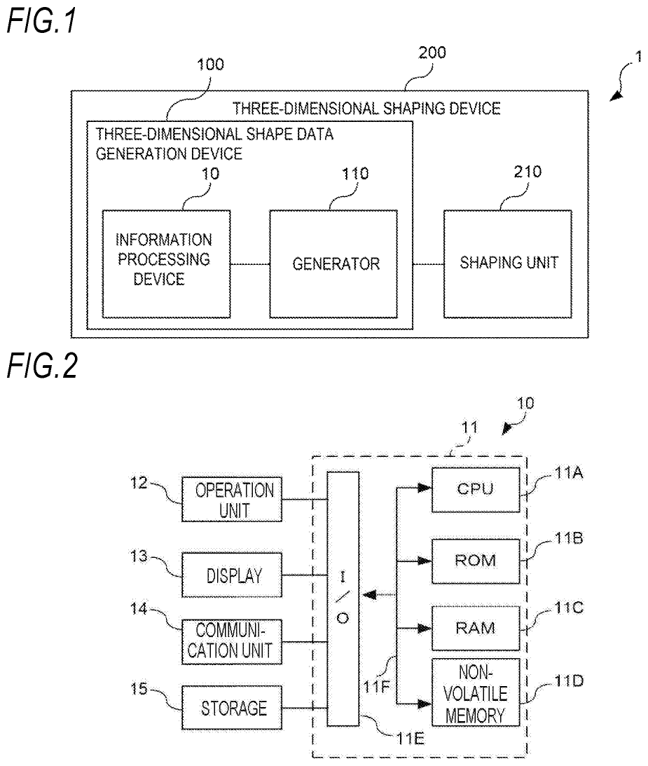

FIG. 1 is a configuration diagram of a three-dimensional shaping system 1 according to the present exemplary embodiment. As illustrated in FIG. 1, the three-dimensional shaping system 1 includes an information processing device 10, a three-dimensional shape data generation device 100, and a three-dimensional shaping device 200. The three-dimensional shape data generation device 100 includes the information processing device 10 and a generator 110, and the three-dimensional shaping device 200 includes the three-dimensional shape data generation device 100 and a shaping unit 210.

In the present exemplary embodiment, descriptions will be made on a configuration where the information processing device 10 is included in the three-dimensional shape data generation device 100, and the three-dimensional shape data generation device 100 is included in the three-dimensional shaping device 200. However, the present exemplary embodiment is not limited thereto. The information processing device 10, the three-dimensional shape data generation device 100, and the three-dimensional shaping device 200 may be separate devices. Alternatively, the information processing device 10 may be a separate device. For example, the three-dimensional shaping device 200 includes the three-dimensional shape data generation device 100, and the information processing device 10 is provided separately. Further alternatively, the three-dimensional shaping device 200 may be a separate device. For example, the three-dimensional shape data generation device 100 includes the information processing device 10, and the three-dimensional shaping device 200 is provided separately.

Next, the configuration of the information processing device 10 according to the present exemplary embodiment will be described with reference to FIG. 2.

The information processing device 10 is implemented by, for example, a personal computer, and includes a controller 11. The controller 11 includes a central processing unit (CPU) 11A, a read only memory (ROM) 11B, a random access memory (RAM) 11C, a non-volatile memory 11D, and an input/output (I/O) interface 11E. The CPU 11A, the ROM 11B, the RAM 11C, the non-volatile memory 11D, and the I/O interface 11E are connected to each other via a bus 11F. The CPU 11A is an example of a processor.

An operation unit 12, a display 13, a communication unit 14, and a storage 15 are connected to the I/O interface 11E.

The operation unit 12 includes, for example, a mouse and a keyboard.

The display 13 is implemented by, for example, a liquid crystal display.

The communication unit 14 is an interface for performing data communication with the generator 110 and an external device.

The storage 15 is implemented by a non-volatile storage device such as a hard disk, and stores an information processing program to be described later and three-dimensional shape data. The CPU 11A reads and executes the information processing program stored in the storage 15.

Next, the functional configuration of the CPU 11A will be described.

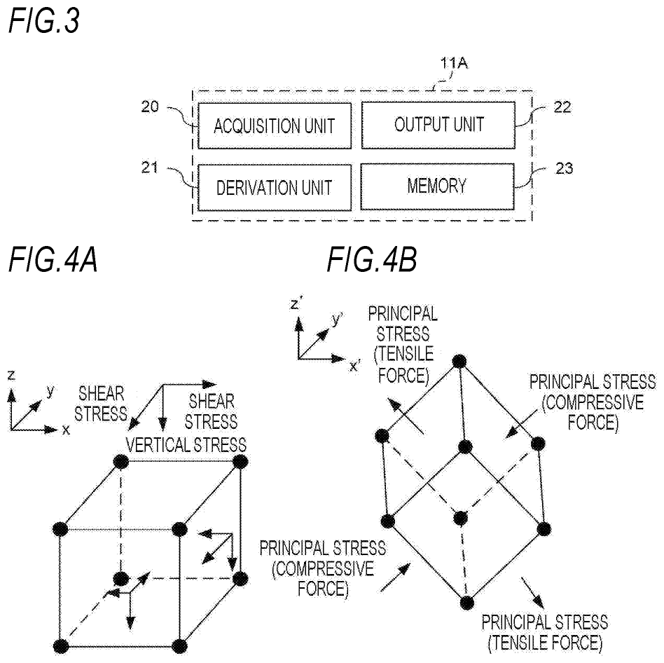

As illustrated in FIG. 3, the CPU 11A functionally includes an acquisition unit 20, a derivation unit 21, an output unit 22, and a memory 23.

The acquisition unit 20 acquires (i) physical property values of an anisotropic material in respective directions and (ii) performance information that is information regarding (a) a required performance that a three-dimensional shape is required to have and (b) a required direction in which the three-dimensional shape is required to exhibit the performance. The anisotropic material has different physical property values in different directions. The acquisition unit 20 acquires priorities of directions of an anisotropic material designated by a user and information regarding the constraints on a direction in which the anisotropic material can be arranged (hereinafter, which will be referred to as “constraint information”).

Descriptions will be made on a mode that the physical property value according to the present exemplary embodiment is a strength which is a mechanical property applied to a three-dimensional shape. However, the present exemplary embodiment is not limited thereto. The physical property value may be any physical property value such as Young's modulus, modulus of rigidity, hardness, and electric conductivity.

The required direction according to the present exemplary embodiment is a direction of stress (load) applied to a three-dimensional shape, and the required performance is a magnitude of stress (load). For example, paying attention to a portion of the three-dimensional shape during shaping of the three-dimensional shape, a tensile force or a compressive force is applied to the portion.

As an example, as illustrated in FIG. 4A, generally, when a stress is applied to any surface of the three-dimensional shape, there are a vertical stress where a load is applied in the vertical direction to the surface, and a shear stress where a load is applied in the horizontal direction to the surface. When a static analysis is performed, as illustrated in FIG. 4B, a coordinate system in which the three-dimensional shape exists is rotated to be converted into a coordinate system in which the shear stress becomes zero. In the present exemplary embodiment, the vertical stress in a coordinate system in which the coordinate system is converted and the shear stress becomes 0 is referred to as the principal stress. The angle of the coordinate system rotated when the coordinates are converted is called the Euler angle.

Therefore, the acquisition unit 20 according to the present exemplary embodiment acquires, as the performance information, the maximum principal stress, the intermediate principal stress, the minimum principal stress in each portion of the three-dimensional shape, and the direction of each principal stress. Here, in the three-dimensional space, the principal stresses in the directions of the x-axis, the y-axis, and the z-axis applied to the three-dimensional shape are referred to as the maximum principal stress, the intermediate principal stress, and the minimum principal stress in the descending order. Further, generally, when the principal stress has a positive value, the principal stress indicates a tensile force, and when the principal stress has a negative value, the principal stress indicates a compressive force.

The constraint information is information such as an angle at which a shaping table in the three-dimensional shaping device 200, which will be described later, may be tilted, an angle at which a laser beam may be emitted, a direction in which the laser beam may be scanned. For example, when the anisotropic material is stacked in the z-axis direction to shape a three-dimensional shape, the constraint information is information such as tilt angles around the x-axis and the y-axis at which the shaping table of each three-dimensional shaping device 200 may be tilted.

The derivation unit 21 derives information for arranging the anisotropic material such that the required direction corresponds to the direction of the anisotropic material satisfying the required performance.

Specifically, when the anisotropic material is arranged such that the direction of the maximum principal stress applied to the three-dimensional shape matches the direction of the anisotropic material related to the physical property value that may correspond to the maximum principal stress, the derivation unit 21 derives an angle for arranging the anisotropic material in each portion of the three-dimensional shape. The angle for arranging the anisotropic material is derived in consideration of the Euler angle and the constraint information.

In addition, the derivation unit 21 derives mutually orthogonal directions in the anisotropic material. For example, when three directions are acquired in the descending order of strength of the anisotropic material, the acquired three directions are not always orthogonal to each other depending on the material. In this case, the derivation unit 21 derives, out of the three directions, the two directions that are orthogonal to the designated central axis and have the maximum strength. Here, of the directions in which the strength is high, the designated direction is called the central axis.

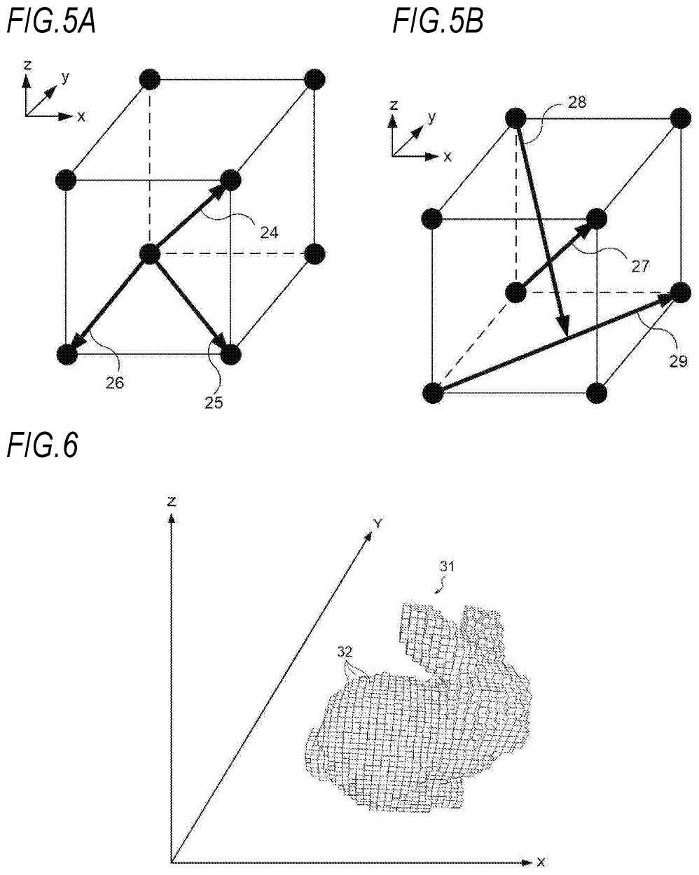

As an example, as illustrated in FIG. 5A, it is assumed that the anisotropic material has three strength directions, that is, the largest strength direction 24 in which the strength is the largest, the middle strength direction 25 in which the strength is the second largest, and the lowest strength direction 26 in which the strength is the third largest. For example, when the direction 24 is designated as the central axis, the derivation unit 21 uses the physical property values in the three directions to derive the two directions that are orthogonal to the central axis and have the maximum strength.

Specifically, as illustrated in FIG. 5B, the derivation unit 21 derives a designated central axis 27 and a direction 28 orthogonal to the central axis 27 and having the largest strength (hereinafter, referred to as a “strong axis”). Further, the derivation unit 21 derives a direction 29 orthogonal to the central axis 27 and the strong axis 28 (hereinafter, referred to as a “weak axis”).

Here, the strong axis 28 is derived by calculating the strength in each direction around the central axis 27 and selecting the largest strength direction. Since the weak axis 29 is limited to two directions when the central axis 27 and the strong axis 28 are determined, the weak axis 29 is derived by selecting the largest strength direction from the two directions.

In the present exemplary embodiment, a mode that, in order to avoid complication, the largest strength direction 24 is designated as the central axis 27 and the strength is increased in the order of the central axis 27, the strong axis 28, and the weak axis 29 will be described. Further, in the present exemplary embodiment, the mode that the largest strength direction 24 is designated as the central axis 27 has been described. However, the present exemplary embodiment is not limited thereto. The direction 25 having the second largest strength after the direction 24 or the direction 26 having the second largest strength after the direction 25 may be designated as the central axis. Further, the priorities may be set in advance such that the first priority is assigned to the largest strength direction 24 in which the strength is the largest, the second priority is assigned to the middle strength direction 25 in which the strength is the second largest, and the third priority is assigned to the lowest strength direction 26 in which the strength is the third largest. Alternatively, the central axis may be set and changed according to the priorities. Further, in the present exemplary embodiment, the mode that the central axis, the strong axis, and the weak axis are selected using a simple cubic lattice has been described. However, the present exemplary embodiment is not limited thereto. They may be selected using a body centered cubic lattice or a face centered cubic lattice.

Further, when the user inputs the three-dimensional shape data of the three-dimensional shape, the derivation unit 21 may derive the performance information for each portion of the three-dimensional shape.

The output unit 22 transmits the angle for arranging the anisotropic material derived by the derivation unit 21 to the generator 110.

The memory 23 stores the physical property value in each direction of the anisotropic material, the constraint information, and the performance information.

Next, a three-dimensional shape 31 will be described with reference to FIG. 6. FIG. 6 is a view illustrating an example of the three-dimensional shape 31 represented by voxel data according to the present exemplary embodiment. FIG. 6 is an example of the three-dimensional shape 31 constructed by voxels 32.

As illustrated in FIG. 6, the three-dimensional shape 31 is three-dimensional shape data indicating a three-dimensional shape constructed by plural voxels 32. Here, the voxel 32 is a basic element of the three-dimensional shape 31 and, for example, a rectangular parallelepiped is used. However, the voxel 32 is not limited to the rectangular parallelepiped but may be a sphere or a cylinder. A desired three-dimensional shape is expressed by stacking the voxels 32.

A three-dimensional shaping method for shaping the three-dimensional shape 31 may include, for example, fused deposition modeling (FDM) for shaping the three-dimensional shape 31 by melting and depositing a thermoplastic resin and selective laser sintering (SLS) for shaping the three-dimensional shape 31 by irradiating and sintering a powdered metal material with a laser beam, but other three-dimensional shaping methods. In the present exemplary embodiment, a case where the three-dimensional shape 31 is shaped using the selective laser sintering will be described.

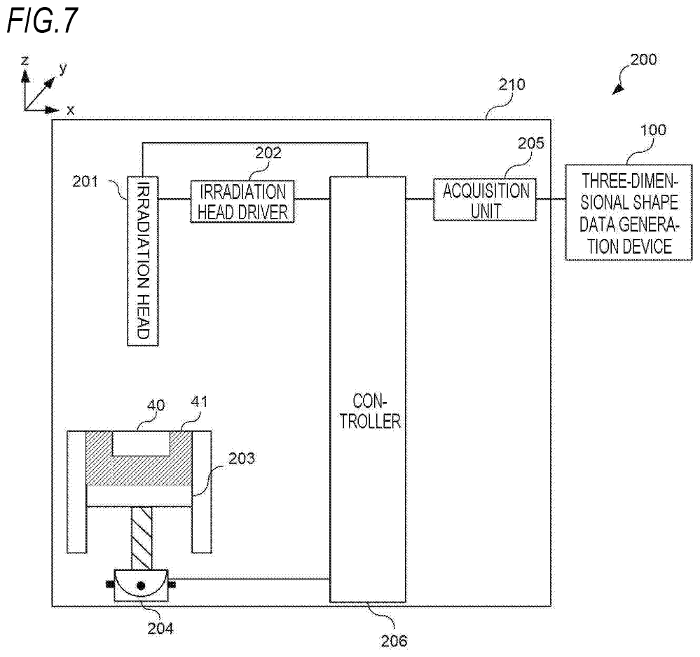

Next, the three-dimensional shaping device 200 that shapes a three-dimensional shape 40 using three-dimensional shape data generated by the three-dimensional shape data generation device 100 will be described. FIG. 7 is an example of the configuration of the three-dimensional shaping device 200 according to the present exemplary embodiment. The three-dimensional shaping device 200 is a device that shapes the three-dimensional shape 40 by the selective laser sintering.

As illustrated in FIG. 7, the three-dimensional shaping device 200 includes an irradiation head 201, an irradiation head driver 202, a shaping table 203, a shaping table driver 204, an acquisition unit 205, and a controller 206. The irradiation head 201, the irradiation head driver 202, the shaping table 203, the shaping table driver 204, the acquisition unit 205, and the controller 206 are examples of the shaping unit 210.

The irradiation head 201 irradiates a shaping material 41 with a laser in order to shape the three-dimensional shape 40.

The irradiation head 201 is driven by the irradiation head driver 202 to two-dimensionally scan on the XY plane.

The shaping table 203 is driven by the shaping table driver 204 to move up and down in the z-axis direction. Further, the shaping table 203 is tilted by the shaping table driver 204 while rotating around the x axis and the y axis. The constraint information according to the present exemplary embodiment includes angles around the x axis and the y axis at which the shaping table 203 may be tilted.

The acquisition unit 205 acquires the three-dimensional shape data generated by the three-dimensional shape data generation device 100. The three-dimensional shape data generation device 100 includes the generator 110 that acquires an angle at which the anisotropic material is arranged, from the information processing device 10, and generates the three-dimensional shape data by applying the acquired angle to each corresponding position of the three-dimensional shape data.

The controller 206 irradiates the shaping material 41 arranged on the shaping table 203 with a laser beam from the irradiation head 201 according to the three-dimensional shape data acquired by the acquisition unit 205, and controls a position and angle at which the irradiation head driver irradiates with the laser beam, and the operating direction of the laser beam.

In addition, the controller 206 performs a control to fill the shaping table 203 with the shaping material 41 by driving the shaping table driver 204 to lower the shaping table 203 by a predetermined deposition interval each time the shaping of each layer is completed. As a result, the three-dimensional shape 40 is shaped under a shaping condition based on the three-dimensional shape data.

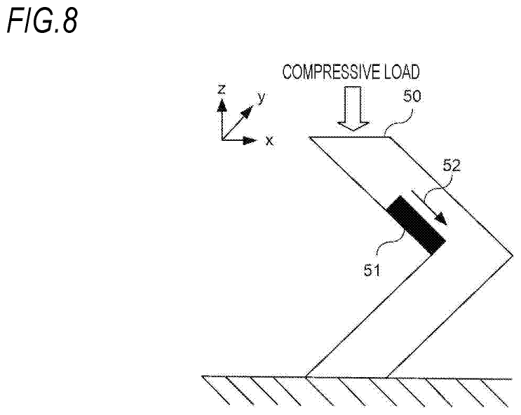

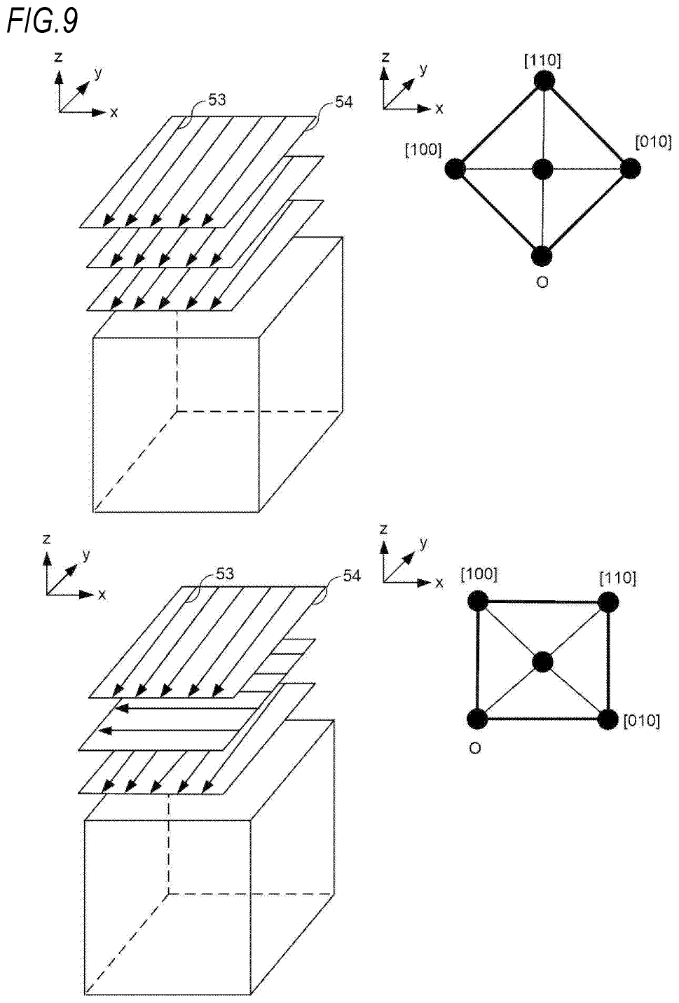

Next, prior to description on the operation of the information processing device 10 according to the present exemplary embodiment, a method of associating the principal stress of the three-dimensional shape with the central axis of the anisotropic material will be described with reference to FIGS. 8 and 9. FIG. 8 is a schematic diagram of the three-dimensional shape, which is used to explain the principal stress applied to a portion of the three-dimensional shape. FIG. 9 is a schematic diagram of the anisotropic material, which is used to explain the arrangement of the anisotropic material according to the present exemplary embodiment.

As an example, as illustrated in FIG. 8, when a compressive load is applied to a three-dimensional shape 50 from above the three-dimensional shape 50 in the z-axis direction, the information processing device 10 derives the principal stress applied to each portion of the three-dimensional shapes 50. For example, when the principal stress direction of each place of the three-dimensional shape 50 is obtained and the direction of the maximum principal stress of a portion 51 of the three-dimensional shape is a direction 52, the information processing device 10 arranges the anisotropic material such that the direction 52 of the maximum principal stress matches the central axis 27 of the anisotropic material.

When determining that the strength of the central axis 27 of the anisotropic material may be adapted to the maximum principal stress, the information processing device 10 outputs to the generator 110 an angle at which the anisotropic material corresponding to the direction 52 of the maximum principal stress is arranged.

The three-dimensional shape data generation device 100 sets the angle acquired from the information processing device 10 at a position corresponding to the portion 51 of the three-dimensional shape data, and outputs the generated three-dimensional shape data to the three-dimensional shaping device 200.

The three-dimensional shaping device 200 shapes the three-dimensional shape 50 while changing the scanning direction of the laser beam according to the angle of the anisotropic material set in the acquired three-dimensional shape data. The crystal orientation when the anisotropic material is sintered is controlled by the laser beam scanning orientation, the tilt of the shaping table, or both the laser beam scanning orientation and the tilt of the shaping table.

A crystal structure generated according to the laser beam scanning direction according to the present exemplary embodiment may be controlled by using a known technique (see, for example, Crystallographic texture control of beta-type Ti-15Mo-5Zr-3Al alloy by selective laser melting for the development of novel implants with a biocompatible low Young's modulus (Scripta Materialia 132(2017) 34-38, Takuya Ishimoto, Koji Hagihara, Kenta Hisamoto, Shi-Hai Sun, Takayoshi Nakano)).

As illustrated in FIG. 9, in the case where a beta-type titanium alloy is used as the anisotropic material, when the anisotropic material is scanned with laser beams in different layers 54 irradiated with the laser beams while the laser beam scanning direction 53 is aligned in a fixed direction, the crystal orientation [110] is aligned in the z-axis direction. Further, when the anisotropic material is scanned with laser beams in the different layers 54 of the anisotropic material in a direction that is alternately orthogonal to the laser beam scanning direction 53, the crystal orientation [100] is aligned in the z-axis direction.

Therefore, when the three-dimensional shaping device 200 is used to shape a three-dimensional shape, the anisotropic material is arranged in a desired direction to shape the three-dimensional shape by controlling the laser beam scanning direction 53 according to an angle set in the three-dimensional shape data. Further, the anisotropic material is arranged in a desired direction by controlling a laser beam irradiation angle and a tilt angle of the shaping table.

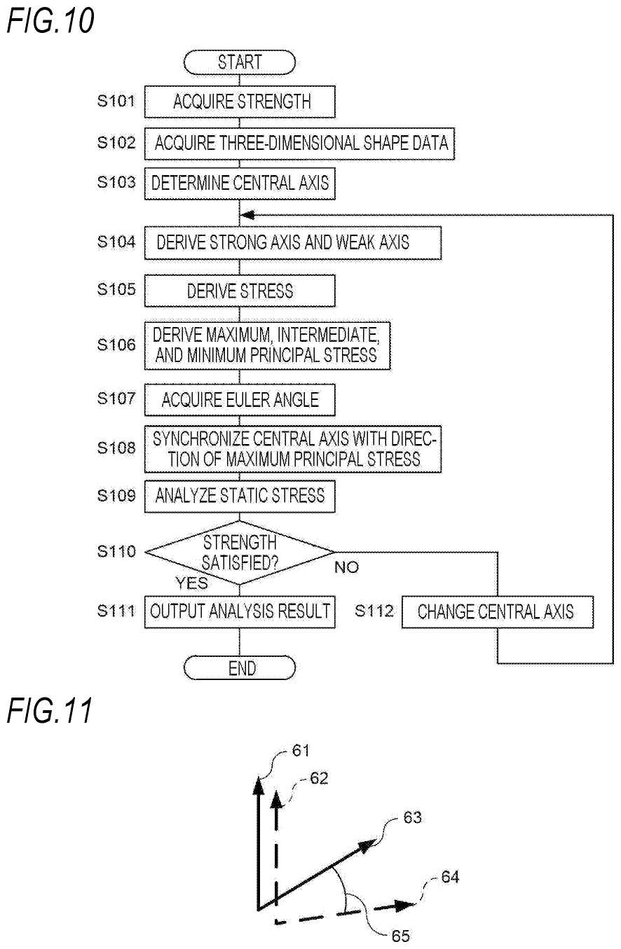

Next, the operation of an information processing program according to the present exemplary embodiment will be described with reference to FIG. 10. FIG. 10 is a flowchart illustrating an example of information processing according to the present exemplary embodiment. When the CPU 11A reads and executes an information processing program from the ROM 11B or the non-volatile memory 11D, the information processing illustrated in FIG. 10 is executed. The information processing illustrated in FIG. 10 is executed, for example, when a user inputs an instruction to execute the information processing program.

In step S101, the CPU 11A acquires the strength of the anisotropic material in each direction.

In step S102, the CPU 11A acquires three-dimensional shape data.

In step S103, the CPU 11A sets a direction in which the strength of the anisotropic material is the largest, as the central axis.

In step S104, the CPU 11A uses the strength for each direction and the direction of the central axis to derive a strong axis and a weak axis, which are two directions orthogonal to the central axis and having the maximum strength.

In step S105, the CPU 11A uses the three-dimensional shape data to derive stresses (shear stress and vertical stress) applied to each portion of the three-dimensional shape.

In step S106, the CPU 11A converts the coordinates in the three-dimensional shape data to derive the maximum, intermediate, and minimum principal stresses applied to each portion of the three-dimensional shape.

In step S107, the CPU 11A acquires an angle (Euler angle) when the coordinates are rotated and converted.

In step S108, the CPU 11A synchronizes the central axis of the anisotropic material with the direction of the maximum principal stress in the three-dimensional shape. Specifically, referring to the angle obtained in step S107, the anisotropic material is arranged such that the central axis of the anisotropic material having the maximum strength matches the direction of the maximum principal stress in the three-dimensional shape.

In step S109, the CPU 11A applies a load to the three-dimensional shape in the three-dimensional shape data in which the central axis is synchronized with the direction of the maximum principal stress in the three-dimensional shape, and performs a static stress analysis.

In step S110, as a result of the static stress analysis, the CPU 11A determines whether the strength of the anisotropic material satisfies a strength that may withstand the maximum principal stress applied to the three-dimensional shape. When it is determined that the strength is satisfied (YES in step S110), the CPU 11A proceeds to step S111. Meantime, when it is determined that the strength is not satisfied (NO in step S110), the CPU 11A proceeds to step S112.

In step S111, the CPU 11A outputs the analysis result to the generator 110. Here, the analysis result is an angle and the Euler angle at which the anisotropic material in each portion of the three-dimensional shape is arranged.

In step S112, the CPU 11A changes the direction of the central axis of the anisotropic material. The change of the central axis may be designated by a user, or the direction of the central axis may be changed according to the order of increasing strength of the anisotropic material. Further, the priorities may be set in advance to plural directions acquired in descending order of strengths of the anisotropic material, and the direction of the central axis may be changed according to the priorities.

As described above, according to the present exemplary embodiment, when designing a three-dimensional shape using an anisotropic material, a required performance can be obtained in a required direction.

### [Second Exemplary Embodiment]

In the first exemplary embodiment, the mode that the anisotropic material is arranged such that the central axis of the anisotropic material (the direction in which the strength becomes maximum) matches the direction of the maximum principal stress in the three-dimensional shape has been described. In a second exemplary embodiment, a mode that the anisotropic material is arranged such that three orthogonal directions in the anisotropic material (central axis, strong axis, and weak axis) correspond to three directions in the three-dimensional shape (directions of maximum principal stress, intermediate principal stress, and minimum principal stress) will be described.

The information processing system configuration according to the second exemplary embodiment (see FIG. 1), the hardware configuration of the information processing device 10 (see FIG. 2), the functional configuration of the information processing device 10 (see FIG. 3), and an example of the principal stress applied to the three-dimensional shape (see FIGS. 4A and 4B) are the same as those in the first exemplary embodiment, and therefore, explanation thereof will not be repeated. In addition, an example of the central axis in the anisotropic material according to the second exemplary embodiment (see FIGS. 5A and 5B), a diagram illustrating the three-dimensional shape data (see FIG. 6), the configuration of the three-dimensional shaping device 200 (see FIG. 7), and an example of the principal stress applied to the three-dimensional shape (see FIG. 8) are the same as those in the first exemplary embodiment, and therefore, explanation thereof will not be repeated. Further, an example of the crystal structure of the anisotropic material according to the second exemplary embodiment (see FIG. 9) is the same as that of the first exemplary embodiment, and therefore, explanation thereof will not be repeated.

As described above in the first exemplary embodiment, when the central axis having the maximum strength of the anisotropic material matches the direction of the maximum principal stress in the three-dimensional shape, although the strength in the direction of the maximum principal stress is satisfied, the strength in the direction of intermediate or minimum principal stress may not be satisfied.

In other words, it is necessary to arrange the anisotropic material in consideration of the directions of the intermediate and minimum principal stresses.

Specifically, after matching the direction of the maximum principal stress in the three-dimensional shape with the central axis where the strength of the anisotropic material is the maximum, the anisotropic material is arranged such that the strong axis, which is a direction in which the strength of the anisotropic material is the second largest, corresponds to the direction of the intermediate principal stress. Further, the anisotropic material is arranged such that the weak axis, which is a direction in which the strength of the anisotropic material is the third largest, corresponds to the direction of the minimum principal stress.

However, depending on the direction of each axis in the anisotropic material, the direction of the principal stress in the three-dimensional shape, and the constraint information, it may not be possible to match the strong axis with the direction of the intermediate principal stress. In this case, the information processing device 10 derives an angle formed by the strong axis in the direction of the anisotropic material that may be arranged, and the direction of the intermediate principal stress, and arranges the anisotropic material in a direction in which the formed angle becomes smaller.

As an example, as illustrated in FIG. 11, the central axis 61 matches the direction of the maximum principal stress 62, and the anisotropic material is arranged such that an angle 65 formed by a strong axis 63 and the direction of an intermediate principal stress 64 becomes smaller.

By arranging the anisotropic material in this way, the strength corresponding to the principal stress may be obtained even when the arrangement of the anisotropic material is limited. In the present exemplary embodiment, descriptions have been made on the mode that the angle formed by the strong axis 63 and the direction of the intermediate principal stress 64 is derived. However, the present exemplary embodiment is not limited thereto. According to the constraint information, when the central axis 61 does not match the direction of the maximum principal stress 62, an angle formed by the central axis 61 and the direction of the maximum principal stress 62 may be derived.

Here, when the central axis 61 corresponds to the direction of the maximum principal stress 62 and the strong axis 63 corresponds to the direction of the intermediate principal stress 64, the weak axis is automatically determined.

In the present exemplary embodiment, descriptions have been made on the mode in which the strong axis corresponds to the direction of the intermediate principal stress and the weak axis corresponds to the direction of the minimum principal stress. However, the present exemplary embodiment is not limited thereto. For example, in the case of a compressive force, since the maximum, intermediate, and minimum principal stresses have negative values, when comparing the absolute values thereof, the minimum principal stress may be larger than the maximum principal stress. In this case, the central axis may correspond to the direction of the minimum principal stress.

Further, when the magnitudes of the maximum, intermediate, and minimum principal stresses are compared with the strengths of the central axis, the strong axis, and the weak axis and a difference between the magnitudes and the strengths is small, the maximum principal stress, intermediate principal stress, and minimum principal stress may correspond to the central axis, the strong axis, and the weak axis, respectively. For example, when the strength in the strong axis is larger than the maximum principal stress and when a difference between the strength of the strong axis and the magnitude of the maximum principal stress is smaller than ones between other combinations, the strong axis may correspond to the direction of the maximum principal stress.

Therefore, when the strength of each axis satisfies the magnitude of each principal stress, axes in the anisotropic material corresponding to the maximum principal stress, intermediate principal stress, and minimum principal stresses may have any combination.

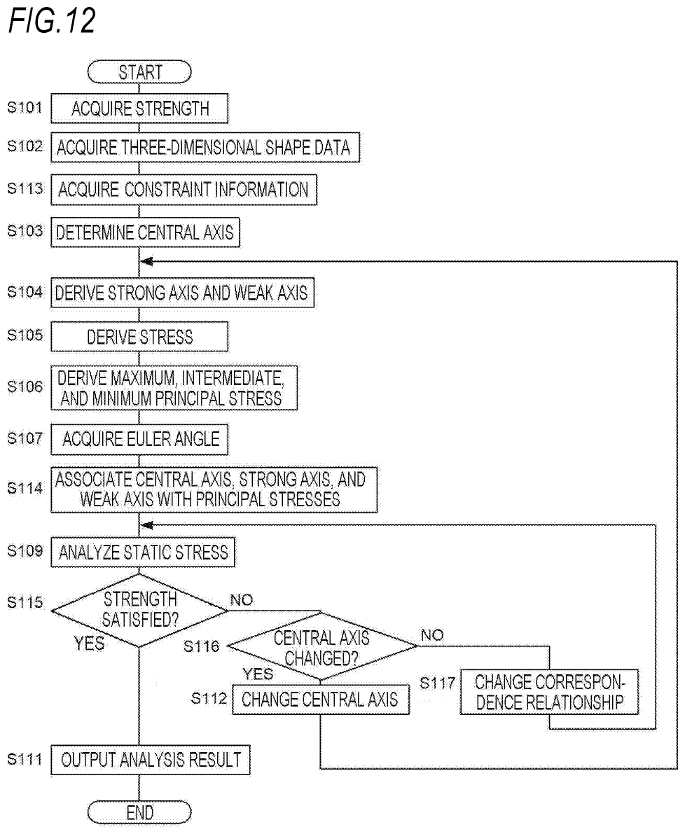

Next, the operation of an information processing program according to the present exemplary embodiment will be described with reference to FIG. 12. FIG. 12 is a flowchart illustrating an example of information processing according to the present exemplary embodiment. When the CPU 11A reads and executes the information processing program from the ROM 11B or the non-volatile memory 11D, the information processing illustrated in FIG. 12 is executed. The information processing illustrated in FIG. 12 is executed, for example, when the user inputs an instruction to execute the information processing program. In FIG. 12, the same steps as those in the information processing illustrated in FIG. 10 are denoted by the same reference numerals as in FIG. 10, and explanation thereof will not be repeated.

In step S113, the CPU 11A acquires constraint information.

In step S114, the CPU 11A associates the central axis, the strong axis, and the weak axis with the maximum principal stress, intermediate principal stress, and minimum principal stresses.

In step S115, as a result of the static stress analysis, the CPU 11A determines whether each strength of the anisotropic material satisfies a strength that may withstand each principal stress. When it is determined that the strength is satisfied (YES in step S115), the CPU 11A proceeds to step S111. Meantime, when it is determined that the strength is not satisfied (NO in step S115), the CPU 11A proceeds to step S116.

In step S116, the CPU 11A determines whether to change the central axis. When it is determined to change the central axis (YES in step S116), the CPU 11A proceeds to step S112. Meantime, when it is determined not to change the central axis (NO in step S116), the CPU 11A proceeds to step S117.

In step S117, the CPU 11A changes the correspondence relationship between the central axis, the strong axis, and the weak axis and the respective principal stresses.

Although the present disclosure has been described above using exemplary embodiments, the present disclosure is not limited to the scope described in the exemplary embodiments. Various modifications and improvements may be made to the exemplary embodiments without departing from the spirit scope of the present disclosure, and the modes that the modifications and improvements are made are also included in the technical scope of the present disclosure.

In the exemplary embodiments, the processor refers to a broadly-defined processor and includes, for example, a general-purpose processor such as a CPU (Central Processing Unit), and a dedicated processor such as a GPU (Graphics Processing Unit), an ASIC (Application Specific Integrated Circuit), or an FPGA (Field Programmable Gate Array), and a programmable logic device.

In addition, the operation of the processor in each of the above-described exemplary embodiments may be performed not only by one processor but also by plural processors existing at physically separated positions in cooperation with each other. The order of operations of the processor is not limited to one described in the exemplary embodiments above, and may be changed.

Further, in the above exemplary embodiments, descriptions have been made on the mode that the information processing program is installed in the storage 15, but the present disclosure is not limited thereto. The information processing program according to the exemplary embodiments may be provided in a form that the information processing program is stored in a computer-readable storage medium. For example, the information processing program according to the present disclosure may be provided in a form recorded in an optical disk such as a compact disc rom (CD-ROM) and a digital versatile disk rom (DVD ROM). The information processing program according to the present disclosure may be provided in a form recorded in a semiconductor memory such as a universal serial bus (USB) memory and a memory card. Further, the information processing program according to the exemplary embodiments may be acquired from an external device via a communication line connected to the communication unit 14.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
when designing a three-dimensional shape made of an anisotropic material that is a material having physical property values in different directions,
acquire (i) the physical property values of the anisotropic material in respective directions and (ii) performance information that is information regarding (a) a required performance that the three-dimensional shape is required to have and (b) a required direction in which the three-dimensional shape is required to exhibit the required performance,
derive information for arranging the anisotropic material such that the required direction corresponds to a direction of the anisotropic material satisfying the required performance, and
output the information for arranging the anisotropic material.

2. The information processing device according to claim 1, wherein
the processor is configured to:
further acquire a plurality of the directions of the anisotropic material and a plurality of the required directions, and
arrange the anisotropic material such that each of the plurality of directions of the anisotropic material corresponds to a respective one of the plurality of required directions.

3. The information processing device according to claim 2, wherein
the processor is configured to:
further acquire priorities of the plurality of directions of the anisotropic material, and
output the information for arranging the anisotropic material according to the priorities.

4. The information processing device according to claim 1, wherein
the processor is configured to:
further acquire constraint information that is information regarding constraints on a direction in which the anisotropic material can be arranged, and
arrange the anisotropic material according to the constraint information.

5. The information processing device according to claim 2, wherein
the processor is configured to:
further acquire constraint information that is information regarding constraints on a direction in which the anisotropic material can be arranged, and
arrange the anisotropic material according to the constraint information.

6. The information processing device according to claim 3, wherein
the processor is configured to:
further acquire constraint information that is information regarding constraints on a direction in which the anisotropic material can be arranged, and
arrange the anisotropic material according to the constraint information.

7. The information processing device according to claim 4, wherein
the processor is configured to:
when the required direction does not correspond to the direction of the anisotropic material, arrange the anisotropic material in a direction that satisfies the required performance and is closest to the required direction among directions in which the anisotropic material can be arranged in accordance with the constraint information.

8. The information processing device according to claim 4, wherein
the processor is configured to:
when the required direction does not correspond to the direction of the anisotropic material, arrange the anisotropic material in a direction in which the anisotropic material has the physical property value closest to the required performance among the directions of the anisotropic material corresponding to the required direction.

9. The information processing device according to claim 1, wherein
the processor is configured to:
arrange the anisotropic material such that a direction in which the physical property value of the anisotropic material is maximum corresponds to the required direction.

10. The information processing device according to claim 4, wherein
the processor is configured to:
arrange the anisotropic material such that a direction in which the physical property value of the anisotropic material is maximum corresponds to the required direction.

11. The information processing device according to claim 7, wherein
the processor is configured to:
arrange the anisotropic material such that a direction in which the physical property value of the anisotropic material is maximum corresponds to the required direction.

12. The information processing device according to claim 8, wherein
the processor is configured to:
arrange the anisotropic material such that a direction in which the physical property value of the anisotropic material is maximum corresponds to the required direction.

13. A three-dimensional shape data generation device comprising:
the information processing device according to claim 1; and
a generator that uses the information derived by the information processing device to generate three-dimensional shape data for shaping the three-dimensional shape such that the direction of the anisotropic material corresponds to the required direction.

14. A three-dimensional shape data generation device comprising:
the information processing device according to claim 2; and
a generator that uses the information derived by the information processing device to generate three-dimensional shape data for shaping the three-dimensional shape such that the directions of the anisotropic material corresponds to the required directions.

15. A three-dimensional shape data generation device comprising:
the information processing device according to claim 3; and
a generator that uses the information derived by the information processing device to generate three-dimensional shape data for shaping the three-dimensional shape such that the directions of the anisotropic material corresponds to the required directions.

16. A three-dimensional shape data generation device comprising:
the information processing device according to claim 4; and
a generator that uses the information derived by the information processing device to generate three-dimensional shape data for shaping the three-dimensional shape such that the direction of the anisotropic material corresponds to the required direction.

17. A three-dimensional shape data generation device comprising:
the information processing device according to claim 5; and
a generator that uses the information derived by the information processing device to generate three-dimensional shape data for shaping the three-dimensional shape such that the directions of the anisotropic material corresponds to the required directions.

18. A three-dimensional shape data generation device comprising:
the information processing device according to claim 6; and
a generator that uses the information derived by the information processing device to generate three-dimensional shape data for shaping the three-dimensional shape such that the directions of the anisotropic material corresponds to the required directions.

19. A three-dimensional shaping device comprising:
the three-dimensional shape data generation device according to claim 13; and
a shaping unit that shapes the three-dimensional shape under shaping conditions according to the three-dimensional shape data generated by the three-dimensional shape data generation device.

20. A non-transitory computer readable medium storing a program that causes a processor to execute information processing, the information processing comprising:
when designing a three-dimensional shape made of an anisotropic material that is a material having physical property values in different directions,
acquiring (i) the physical property values of the anisotropic material in respective directions and (ii) performance information that is information regarding (a) a required performance that the three-dimensional shape is required to have and (b) a required direction in which the three-dimensional shape is required to exhibit the performance,
deriving information for arranging the anisotropic material such that the required direction corresponds to a direction of the anisotropic material in which the physical property value of the anisotropic material satisfying the required performance is achieved, and
outputting the information for arranging the anisotropic material.
